(19) United States
(12) Patent Application Publication
(10) Pub. No.: US 2013/0321105 A1
(43) Pub. Date: Dec. 5, 2013

(54) STRIPLINE CONNECTION APPARATUS

(71) Applicants: Young-Chan Moon, Suwon (KR); In-Ho Kim, Yongin (KR); Seong-Man Kang, Hwaseong (KR); Dong-Hun Oh, Hwaseong (KR)

(72) Inventors: Young-Chan Moon, Suwon (KR); In-Ho Kim, Yongin (KR); Seong-Man Kang, Hwaseong (KR); Dong-Hun Oh, Hwaseong (KR)

(73) Assignee: KMW INC., Hwaseong, Gyeonggi-Do (KR)

(21) Appl. No.: 13/984,606

(22) PCT Filed: Feb. 9, 2012
(86) PCT No.: PCT/KR2012/000947

§ 371 Date: Aug. 9, 2013

(30) Foreign Application Priority Data
Feb. 14, 2011 (KR) 10-2011-0013031
Apr. 7, 2011 (KR) 10-2011-0032366

(51) Int. Cl. H01P 3/08

(52) U.S. Cl. CPC H01P 3/08
USPC 333/246

(57) ABSTRACT

The present invention relates to a stripline connection apparatus for transmitting signals between at least one pair of striplines. The stripline connection apparatus comprises a coupling member arranged between the pair of striplines so as to transmit signals to each stripline via inductive coupling. The coupling member includes a conductor, both ends of which face the respective striplines, and a gap-maintaining means for maintaining a predetermined gap between the conductor and the striplines.

### TECHNICAL FIELD

The present invention relates to a structure of a strip-line suitable for use as a transmission line in an antenna for a mobile communication base station, and more particularly, to a connection device between strip-lines.

### BACKGROUND ART

In various devices for processing Radio Frequency (RF) signals as well as antennas for mobile communication base stations, schemes using coaxial cables, micro-strip-lines, and strip-lines are generally used to implement RF transmission lines.

The coaxial cables have been widely used as transmission lines in various technical fields, and are often used as RF transmission lines. Recently, however, due to cost reduction or the like, schemes using strip-lines as RF transmission lines have also come into wide use.

When a transmission line is implemented using a strip-line, multiple strip-lines are separately designed and are connected to each other for transmission line implementation of a device. To connect the strip-lines, soldering is generally used.

As such, to connect separate parts of two strip-lines, soldering is generally used, but for soldering, the part of the strip-line should be plated (but the plating is not necessarily performed prior to soldering), or the strip-line should be made of a copper material, which is relatively expensive, increasing cost.

Laser welding, which does not need plating, may be used, but equipment investment cost and work efficiency are degraded.

Moreover, Passive Inter-Modulation Distortion (PIMD), which is one of antenna characteristics, is affected by incomplete mechanical connection, such that complete mechanical connection is desirable. However, welding is weak to corrosion and as corrosion progresses, the PIMD characteristic deteriorates.

### SUMMARY

Accordingly, the present invention provides a strip-line connection structure which is simple, connects strip-lines at a low cost, and prevents signal characteristic degradation.

According to an aspect of the present invention, there is provided a strip-line connection device for transmitting signals between at least a pair of strip-lines, the strip-line connection device including a coupling member for transmitting signals to each strip-line in a contact-free coupling manner between the at least a pair of the strip-lines, in which the coupling member includes a conductor, both end portions of which face the strip-lines, respectively, and a space-maintaining means installed to maintain a predetermined space between the conductor and each strip-line.

The space-maintaining means may be an insulating layer formed to have a predetermined thickness on the conductor.

The coupling member may be a Printed Circuit Board (PCB), the conductor may be a conductive pattern formed on the PCB, and the space-maintaining means may be an insulating layer formed to have a uniform thickness on the pattern.

The insulating layer may be made of a polyamide material.

The conductor may be an anodized conductive metallic plate, and the insulating layer may be an anodized oxide layer of the conductive metallic plate.

At least one through-holes communicating with each other may be formed in the coupling member and each strip-line, and rivets made of an insulating material may be engaged through the through-holes to fix the coupling member and each strip-line.

The strip-line connection device may further include at least one fixing clips for fixing the coupling member and each strip-line

As described above, a strip-line connection structure which is simple, connects strip-lines at a low cost, and prevents signal characteristic degradation.

### BRIEF DESCRIPTION OF DRAWINGS

FIG. 1 is a perspective view illustrating an example of a strip-line connection portion using a strip-line connection device according to an embodiment of the present invention;

FIG. 2 is a perspective view illustrating a strip-line connection device according to an embodiment of the present invention;

FIG. 3 is a side cross-sectional view illustrating a strip-line connection device according to an embodiment of the present invention;

FIG. 4 is a side cross-sectional view illustrating a structure for fixing a strip-line and a coupling member in a strip-line connection device according to another embodiment of the present invention; and

FIG. 5 is a side cross-sectional view illustrating a strip-line connection device according to another embodiment of the present invention.

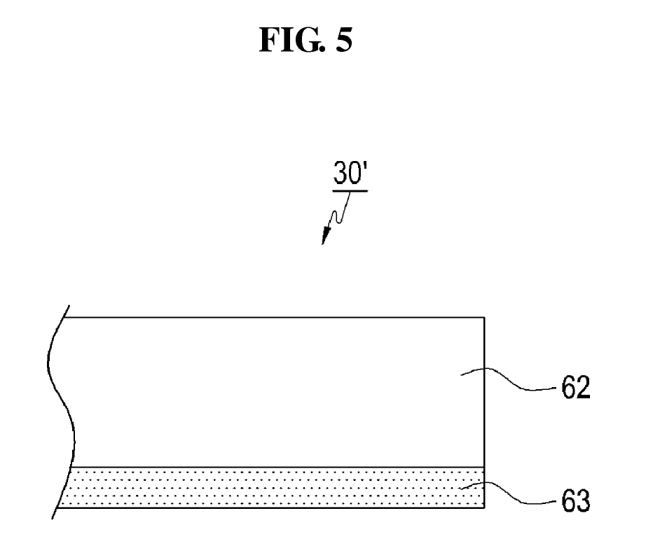

### DETAILED DESCRIPTION

Hereinafter, embodiments of the present invention will be described in detail. In a description of the present invention, well-known functions and structures which may unnecessarily obscure the subject matter of the present invention will not be described.

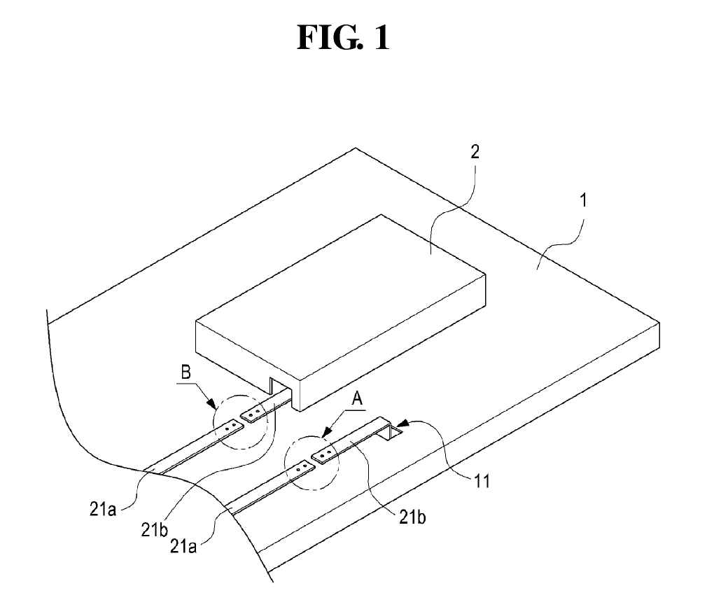

FIG. 1 is a perspective view illustrating a strip-line connection portion using a strip-line connection device according to an embodiment of the present invention, in which the present invention is applied to a mobile communication base station antenna.

Referring to FIG. 1, in a strip-line connection device according to the present invention, in mechanically discontinuous sections A and B of two strip-lines 21a and 21b to be connected, portions of the strip-lines 21a and 21b to be connected are formed to face each other with an appropriately spaced distance therebetween.

In a device for implementing a strip-line as a transmission line, it is desirable not to have the aforementioned mechanically discontinuous section in the strip-line if possible. However, in FIG. 1, for connection with an accessory device 2 (for example, a phase shifter) in which a transmission line is formed with a strip-line, as indicated by the section A, or for installation of a strip-line on the other surface of an antenna reflecting plate 1, which serves as a ground plate, through a hole formed in the antenna reflecting plate 1 as indicated by the section B, a mechanically discontinuous section in the strip-line is inevitable.

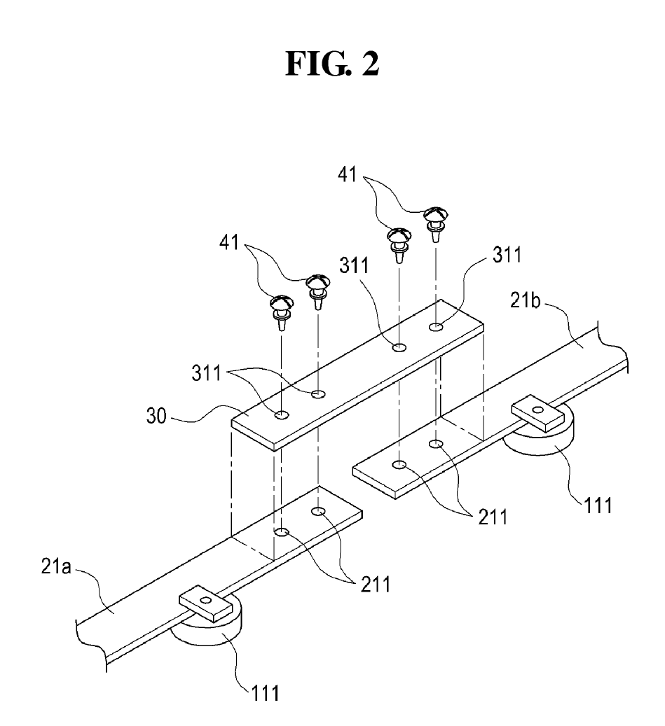

In the present invention, in the mechanically discontinuous sections A and B of the two strip-lines to be connected, as illustrated in FIG. 1, the portions of the two strip-lines 21a and 21b to be connected are formed to face each other with an appropriately spaced distance therebetween, and then the portions of the two strip-lines 21a and 21b formed to face each other with the appropriately spaced distance are connected to each other in a contact-free coupling manner by using a coupling member (30 of FIG. 2) formed according to the present invention and thus transmit signals therebetween.

The spaced distance between end portions of the strip-lines 21a and 21b to be connected is appropriately set such that the end portions do not contact each other in spite of an external shock or expansion of the strip-lines 21a and 21b due to temperature. When the spaced distance is set, electric characteristics are not an important consideration.

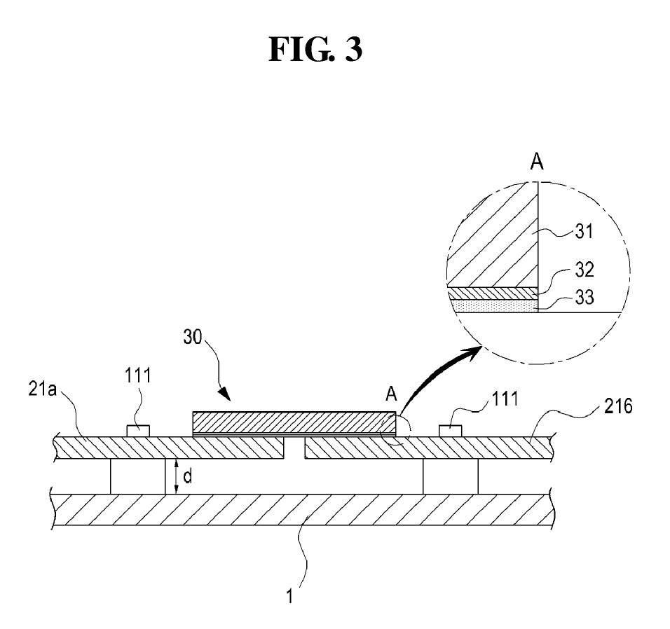

FIG. 2 is a perspective view illustrating a strip-line connection device according to an embodiment of the present invention, and FIG. 3 is a side cross-sectional view illustrating a strip-line connection device according to an embodiment of the present invention. The strip-line connection device illustrated in FIGS. 2 and 3 may be regarded as being installed on the antenna reflecting plate 1 illustrated in FIG. 1. Referring to FIGS. 2 and 3, the strip-line connection device according to the present invention includes a coupling member 30 installed between at least a pair of strip-lines 21a and 21b to be connected for transmitting signals in a contact-free coupling manner.

More specifically, the coupling member 30 includes a conductor 32, an end of which transmits a signal to an end portion of one of the two strip-lines 21a and 21b to be connected, in a contact-free coupling manner, and the other end of which transmits a signal to an end portion of the other of the two strip-lines 21a and 21b to be connected, in a contact-free coupling manner, and a space-maintaining means 33 installed to maintain a predetermined space between the conductor 32 and the respective strip-lines 21a and 21b. The coupling member 30 may be installed in a form covering both end portions of the two strip-lines 21a and 21b. The coupling member 30 is fixedly installed in the both end portions of the two strip-lines 21a and 21b, and to this end, at least one through-holes communicating with each other are formed in the coupling member 30 and the strip-lines 21a and 21b. Rivets 41 of an insulating material may be engaged through the through-holes. For example, multiple through-holes 311 are formed in place in one end and the other end of the coupling member 30, and through-holes 211 having sizes corresponding to the through-holes 311 of the coupling member 30 are formed in positions corresponding to the through-holes 311 in the both end portions of the two strip-lines 21a and 21b. Through the through-holes 311 of the coupling member 30 and the through-holes 211 of the two strip-lines 21a and 21b, the rivets 41, which are made of a plastic material and have corresponding sizes, are engaged, such that the coupling member 30 is fixedly installed in the two strip-lines 21a and 21b.

To describe the structures of the coupling member 30 and the two strip-lines 21a and 21b in more detail, the strip-lines 21a and 21b may be implemented with strip plates with a thickness of 1 mm and a width of 8.6 mm, which have an impedance value of 50 Ω in an air space having a height d of 2 mm from the ground plate (that is, for example, the antenna reflecting plate) 1. A design structure and an impedance as well as a spaced distance (height) between the strip-lines 21a and 21b and the ground plate 1 are very precisely and carefully considered, and therefore, to maintain the spaced distance (height) between the strip-lines 21a and 21b and the ground plate 1, it is desirable to install spacers 111 having a proper structure and a proper material between the strip-lines 21a and 21b and the ground plate 1.

The coupling member 30 may be generally implemented with a Printed Circuit Board (PCB) structure, and as illustrated in FIG. 3, the conductor 32 may be a conductive pattern formed on the PCB, and the space-maintaining means 33 may be an insulating layer formed to have a uniform thickness on the conductive pattern (a bottom surface in the drawing). The coupling member 30 also includes a PCB dielectric plate 31 formed on a top surface (in the drawing) of the conductor 32 to maintain the shape of the coupling member 30.

As such, it can be seen that the conductor 32 of the coupling member 30 maintains a predetermined space with the strip-lines 21a and 21b by means of the insulating layer 33. A general method for insulating a PCB copper plate uses Photo Solder Resist (PSR), but a PSR film has a non-uniform thickness. Thus, to maintain a predetermined insulating space and endure high-temperature heat that may be generated in the strip-line, the insulating layer 33 is formed by compressing a polyamide film at high temperature in the embodiment of the present invention.

Contact-free coupling between the coupling member 30 and the strip-lines 21a and 21b is designed considering various factors to generate a minimum loss (VSWR, coupling loss). For example, in the foregoing case, a coupling section may be designed as 20 mm, a dielectric constant of the PCB dielectric plate 31 may be designed as 4.1, a thickness of the PCB dielectric plate 31 may be designed as 0.8 mm, a thickness of the copper conductor 32 may be designed as 0.034 mm, and a thickness of the insulating layer 33, which is made of a polyamide film, may be designed as 0.028 mm.

The two strip-lines 21a and 21b may be connected in a contact-free coupling manner by using the coupling member 30 having the foregoing structure according to an embodiment of the present invention, and meanwhile, end portions of the two strip-lines 21a and 21b may overlap each other to form an insulating layer in overlapping portions for signal transmission in a contact-free coupling manner. However, in such a structure, a height of at least one of the overlapping strip-lines is changed in an unwanted direction with respect to a ground plate, having a negative influence upon signal transmission. For this reason, this structure is not desirable.

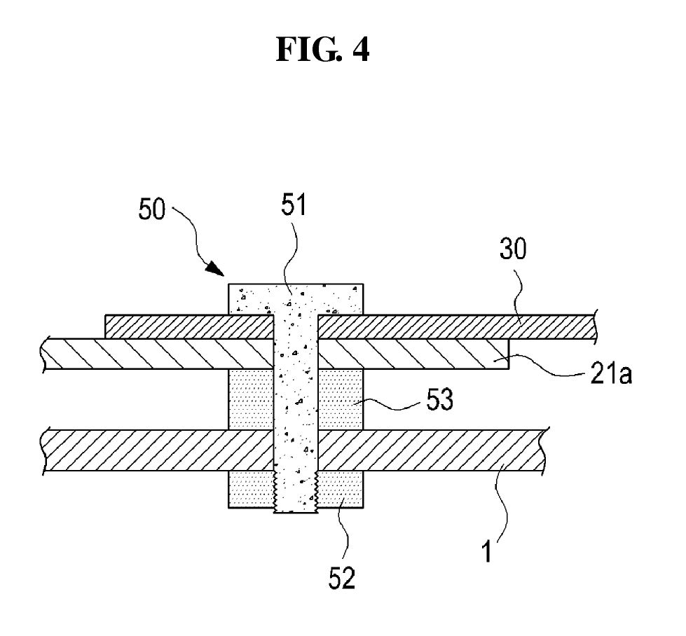

FIG. 4 is a side cross-sectional view illustrating a structure for fixing the strip-lines 21a and 21b and the coupling member 30 in the strip-line connection device according to another embodiment of the present invention. Referring to FIG. 4, in another embodiment of the present invention, a fixing means 50 for fixing the coupling member 30 and the strip-line 21a includes a male-screw structure 51 installed through a hole formed to correspond to the coupling member 30, the strip-line 21a, and the ground plate 1, a ring structure 53 installed between the ground plate 1 and the strip-line 21a in such a way to be inserted into the male-screw structure 51, thus serving as a spacer, and a female-screw structure 52 coupled to a screw thread of the male-screw structure 51 on a rear surface of the ground plate 1.

For fixing the coupling member and the strip-lines, a fixing clip for picking up the coupling member and the corresponding strip-line may be used, or bonding may be used. In this manner, the strip-line connection structure according to an embodiment of the present invention may be implemented, and while a detailed embodiment has been described in the foregoing description of the present invention, various modifications may be carried out without departing from the scope of the present invention. For example, the structure for connecting two strip-lines has been described in the foregoing embodiment, but a structure for connecting three strip-lines may also be implemented by including a T-shaped coupling member, and by using the coupling member according to the embodiment of the present invention, the two strip-lines may also be connected in the form of T.

Moreover, while the coupling member is implemented with the PCB structure in the foregoing description, in another embodiment of the present invention, a conductor of a coupling member 30′ may be implemented with an anodized conductive metallic plate, for example, an aluminum plate 62, and in this case, an insulating layer may be implemented with an anodizing oxide layer 63 of the aluminum plate. The conductive metallic plate may also be implemented with an aluminum alloy, magnesium, or tin as well as pure aluminum.

As such, various modifications or changes of the present invention may fall within a scope that does not depart from the subject matter of the present invention.

1. A strip-line connection device for transmitting signals between at least a pair of strip-lines, the strip-line connection device comprising:
a coupling member for transmitting signals to each strip-line in a contact-free coupling manner between the at least a pair of the strip-lines,
wherein the coupling member comprises:
a conductor, both end portions of which face the strip-lines, respectively; and
a space-maintaining means installed to maintain a predetermined space between the conductor and each strip-line.

2. The strip-line connection device of claim 1, wherein the space-maintaining means is an insulating layer formed to have a predetermined thickness on the conductor.

3. The strip-line connection device of claim 1, wherein the coupling member is a Printed Circuit Board (PCB),
the conductor is a conductive pattern formed on the PCB, and
the space-maintaining means is an insulating layer formed to have a uniform thickness on the pattern.

4. The strip-line connection device of claim 2, wherein the insulating layer is made of a polyamide material.

5. The strip-line connection device of claim 2, wherein the conductor is an anodized conductive metallic plate, and
the insulating layer is an anodized oxide layer of the conductive metallic plate.

6. The strip-line connection device of claim 1, wherein at least one through-holes communicating with each other are formed in the coupling member and each strip-line, and rivets made of an insulating material are engaged through the through-holes to fix the coupling member and each strip-line.

7. The strip-line connection device of claim 1, further comprising at least one fixing clips for fixing the coupling member and each strip-line.
